(19) United States
(12) Patent Application Publication
(10) Pub. No.: US 2025/0364590 A1
(43) Pub. Date: Nov. 27, 2025

(54) NEW Li-CONDUCTOR PROTOTYPES IN THE Li-Zr-Si-O CHEMICAL SPACE FOR SOLID-STATE BATTERIES

(71) Applicant: SAMSUNG ELECTRONICS CO., LTD., Suwon-si (KR)

(72) Inventors: Qingjie LI, Arlington, CA (US); Mahdi AMACHRAA, San Diego, CA (US); Yan WANG, Brookline, MA (US)

(73) Assignee: SAMSUNG ELECTRONICS CO., LTD., Suwon-si (KR)

(21) Appl. No.: 18/889,808

(22) Filed: Sep. 19, 2024

Related U.S. Application Data
(60) Provisional application No. 63/650,425, filed on May 22, 2024.

(51) Int. Cl. H01M 10/0562; H01M 4/02; H01M 4/04; H01M 10/0525

(52) U.S. Cl. CPC H01M 10/0562; H01M 4/0402; H01M 10/0525; H01M 2004/021; H01M 2300/0071

(57) ABSTRACT

A lithium-containing oxide has the parent composition Li2ZrSiO5 and includes Li2ZrSiO5 which is crystallized in space group Pc, Cc, Pmn2₁, P2₁, Pna2₁, P2₁2₁2₁, P4₃, Pca2₁, P2₁/c, Pbca, C2/c, Pmc2₁, or P4/nmm. A lithium solid-state battery includes an anode, a cathode, and a solid electrolyte, wherein the solid electrolyte includes the aforementioned lithium-containing oxide. Also, a solid-state battery includes an anode, a cathode, and a solid electrolyte, wherein at least one of the anode and the cathode is coated with a coating which includes the aforementioned lithium-containing oxide.

### CROSS-REFERENCE TO RELATED APPLICATION

This application is based on and claims priority from U.S. Provisional Application No. 63/650,725 filed on May 22, 2024 in the U.S. Patent and Trademark Office, the disclosure of which is incorporated herein by reference in its entirety.

### BACKGROUND

### 1. Field

Materials according to embodiments relate to ionic conductors for use as solid electrolytes in Li solid-state batteries and/or for use as electrode coatings for solid-state batteries.

### 2. Description of the Related Art

The fast development of portable electronics and electric vehicles has increased the demand for electrochemical energy storage system. In the meantime, the related safety issues are gathering more attention.

Due to the flammability and possible leakage, organic liquid electrolytes pose a safety risk in conventional Li-ion batteries. In this context, solid-state batteries (SSBs) are considered to be the next-generation batteries with improved safety and energy density. An all solid state battery is shown in FIG. 1. In FIG. 1, the all solid component can comprise solid cathode particles in a solid catholyte, and the solid separator can comprise a solid electrolyte.

Solid-state lithium-ion conductors with high ionic conductivities play an important role in SSBs. During the past two decades, there has been an increasing amount of work on new solid-state lithium-ion conductors (SSLICs). And most of them are focused on sulfide SSLICs with high ionic conductivities. However, very limited number of oxide materials were developed for SSBs, and so far only lithium garnet is considered to be the oxide-type electrolyte for lithium SSBs.

For solid-state electrolytes in SSBs, sulfide-based materials have high ionic conductivities (>10 mS/cm) but not really safe (H2S in air condition) and have limited electrochemical stability (for example, unstable against Li metal).

Oxide SSLICs, which own better electrochemical and chemical stability than sulfide SSLICs, have been largely limited in garnet-type materials. The ionic conductivities of reported oxide SSLICs are generally lower than those of sulfide SSLICs.

Solid state electrolyte materials with superionic conductivity and interfacial stability are desirable materials to form all-solid-state Li-metal batteries. However, several problems and challenges are currently being investigated, such as achieving high ionic conductivity at room temperature, ensuring good interfaces between solid-state electrolytes and electrode materials, developing cost-effective solid-state-electrolytes that can compete with currently established liquid electrolyte technologies is also a hurdle for widespread adoption. Currently, very few Li-oxide conductors have been uncovered. Consequently, discovering new compositions within the Li—Zr—Si—O chemical space is a promising venture to uncover simple, cost-effective, high stability Li-conductors.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

The present disclosure focuses on presenting novel compositions within the Li—Zr—Si—O chemical space by applying a machine learning-based crystal structure prediction algorithm.

In this disclosure, novel lithium-containing oxides include the following parent composition: Li2ZrSiO5.

The lithium-containing oxides in this disclosure can be used as a solid electrolyte material for Li batteries and/or electrode coatings for solid-state batteries.

This disclosure provides lower cost/high conductivity and high aqueous stability solid electrolyte for use in Li solid-state batteries.

A first embodiment of the present disclosure provides a lithium-containing oxide comprising Li2ZrSiO5 which is crystallized in space group Pc, Cc, Pmn2₁, P2₁, Pna2₁, P2₁2₁2₁, P4₃, Pca2₁, P2₁/c, Pbca, C2/c, Pmc2₁, or P4/nmm.

A second embodiment of the present disclosure provides a lithium-containing oxide of the first embodiment, wherein the lithium-containing oxide is Li2ZrSiO5 crystallized in space group Pc.

A third embodiment of the present disclosure provides a lithium-containing oxide of the first embodiment, wherein the lithium-containing oxide is Li2ZrSiO5 crystallized in space group Cc.

A fourth embodiment of the present disclosure provides a lithium-containing oxide of the first embodiment, wherein the lithium-containing oxide is Li2ZrSiO5 crystallized in space group Pmn2₁.

A fifth embodiment of the present disclosure provides a lithium-containing oxide of the first embodiment, wherein the lithium-containing oxide is Li2ZrSiO5 crystallized in space group P2₁.

A sixth embodiment of the present disclosure provides a lithium-containing oxide of the first embodiment, wherein the lithium-containing oxide is Li2ZrSiO5 crystallized in space group Pna2₁.

A seventh embodiment of the present disclosure provides a lithium-containing oxide of the first embodiment, wherein the lithium-containing oxide is Li2ZrSiO5 crystallized in space group P2₁2₁2₁.

An eighth embodiment of the present disclosure provides a lithium-containing oxide of the first embodiment, wherein the lithium-containing oxide is Li2ZrSiO5 crystallized in space group P4₃.

A ninth embodiment of the present disclosure provides a lithium-containing oxide of the first embodiment, wherein the lithium-containing oxide is Li2ZrSiO5 crystallized in space group Pca2₁.

A tenth embodiment of the present disclosure provides a lithium-containing oxide of the first embodiment, wherein the lithium-containing oxide is Li2ZrSiO5 crystallized in space group P2₁/c.

An eleventh embodiment of the present disclosure provides a lithium-containing oxide of the first embodiment, wherein the lithium-containing oxide is Li2ZrSiO5 crystallized in space group Pbca.

A twelfth embodiment of the present disclosure provides a lithium-containing oxide of the first embodiment, wherein the lithium-containing oxide is Li2ZrSiO5 crystallized in space group C2/c.

A thirteenth embodiment of the present disclosure provides a lithium-containing oxide of the first embodiment, wherein the lithium-containing oxide is Li2ZrSiO5 crystallized in space group Pmc2₁.

A fourteenth embodiment of the present disclosure provides a lithium-containing oxide of the first embodiment, wherein the lithium-containing oxide is Li2ZrSiO5 crystallized in space group P4/nmm.

A fifteenth embodiment of the present disclosure provides a lithium solid-state battery comprising an anode, a cathode, and a solid electrolyte, wherein the solid electrolyte comprises the lithium-containing oxide of parent composition Li2ZrSiO5.

A sixteenth embodiment of the present disclosure provides a lithium solid-state battery of the fifteenth embodiment, wherein the solid electrolyte comprises Li2ZrSiO5 crystallized in space group Pc, Cc, Pmn2₁, P2₁, Pna2₁, P2₁2₁2₁, P4₃, Pca2₁, P2₁/c, Pbca, C2/c, Pmc2₁, or P4/nmm.

A seventeenth embodiment of the present disclosure provides a lithium solid-state battery comprising an anode, a cathode, and a solid electrolyte, wherein at least one of the anode and the cathode is coated with a coating which comprises the lithium-containing oxide of the first embodiment.

An eighteenth embodiment of the present disclosure provides a lithium solid-state battery of the seventeenth embodiment, wherein the coating comprises Li2ZrSiO5 crystallized in space group Cc.

A nineteenth embodiment of the present disclosure provides a lithium solid-state battery of the seventeenth embodiment, wherein the cathode is coated with the coating which comprises the lithium-containing oxide.

A twentieth embodiment of the present disclosure provides a lithium solid-state battery of the eighteenth embodiment, wherein the cathode is coated with the coating which comprises Li2ZrSiO5 crystallized in space group Cc.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Example embodiments of the present disclosure will be more clearly understood from the following detailed description taken in conjunction with the accompanying drawing in which:

FIG. 1 shows an all solid-state battery.

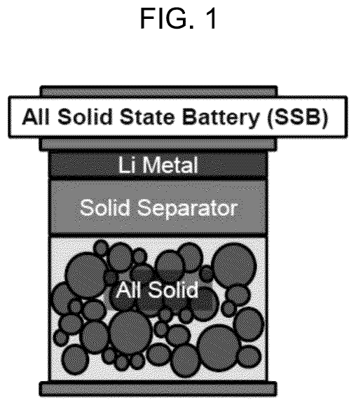

FIG. 2 shows Li2ZrSiO5 crystallized in space group Pc or Pna2₁.

FIG. 3 shows Li2ZrSiO5 crystallized in space group Cc.

FIG. 4 is a graph showing the calculated powder diffraction pattern of Li2ZrSiO5 crystallized in space group Pc or Pna2₁.

FIG. 5 is a graph showing the calculated powder diffraction pattern of Li2ZrSiO5 crystallized in space group Cc.

FIG. 6 is a graph showing the calculated Li-ion conductivity of Li2ZrSiO5 crystallized in space group Pc or Pna2₁.

FIG. 7 is a graph showing the calculated Li-ion conductivity of Li2ZrSiO5 crystallized in space group Cc.

### DETAILED DESCRIPTION OF EXAMPLE EMBODIMENTS

The present disclosure demonstrates several novel compositions within the Li—Zr—Si—O chemical space with Li-ion conductivity.

In this disclosure, novel lithium-containing oxides include the following parent composition: Li2ZrSiO5.

That is, in this disclosure, novel Li-ion prototypes within the Li—Zr—Si—O chemical space include the following parent formula: Li2ZrSiO5.

The Li2ZrSiO5 may crystallize in at least 13 distinct space groups: Pc, Cc, Pmn2₁, P2₁, Pna2₁, P2₁2₁2₁, P4₃, Pca2₁, P2₁/c, Pbca, C2/c, Pmc2₁, P4/nmm. That is, the new Li-ion conductor prototype Li2ZrSiO5 may crystallize in 13 distinct space groups: Pc, Cc, Pmn2₁, P2₁, Pna2₁, P212121, P43, Pca2₁, P2₁/c, Pbca, C2/c, Pmc2₁, P4/nmm.
The Zr and Si positions in the Li2ZrSiO5 composition can occupy several spatial distributions leading a variety of ways to construct the Li2ZrSiO5 structure.
Each spatial distribution of La and Li will lead to a different energy above hull, varying from 0.0 meV/atom to 58.57 meV/atom.
The Li sites may occupy an octahedron, square pyramid, square plane, see-saw, square non-coplanar, tetrahedron, triangular non-coplanar and trigonal plane polyhedron.
The Zr sites may occupy an octahedron, trigonal bipyramid, and square pyramid polyhedron, while the Si site may only occupy a tetrahedron site.
The Li activation energy (3-dimensional) in this phase varies from 0.459 eV to 3.59 eV, depending on the Li/Zr/Si spatial distribution within the compound. These results indicate that certain claimed phases have a high potential for Li-conductivity in 3-dimension.
The Li activation energy (2-dimensional) in this phase varies from 0.1855 eV to 2.13 eV, depending on the Li/Zr/Si spatial distribution within the compound. These results indicate that certain claimed phases have a high potential for Li-conductivity in 2-dimension.
The Li activation energy (1-dimensional) in this phase varies from 0.16 eV to 0.92 eV, depending on the Li/Zr/Si spatial distribution within the compound. These results indicate that certain claimed phases have a high potential for Li-conductivity in 1-dimension.
The reduction potential against Li is 0.83 V, while the oxidation potential is 3.74 V, suggesting that this material can be used as anolyte against an alloy anode or graphite anode, or catholyte against cathodes with coatings.
The disclosed materials show high predicted ionic conductivities as high as 35 or 44 mS/cm at R.T. for the top 2 candidate materials, respectively.
The disclosed materials are expected to be cost-effective than the state-of-the-art oxide SSLICs.

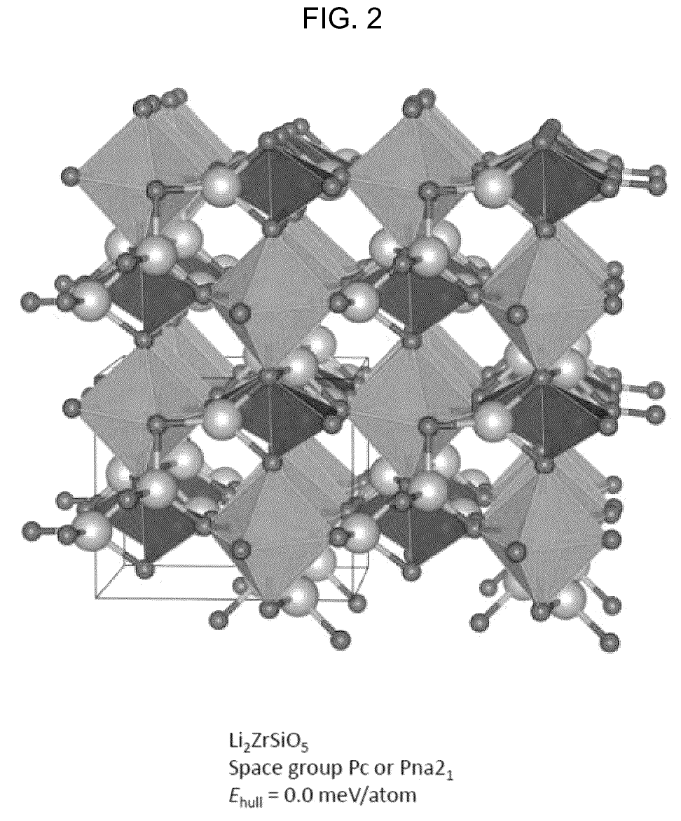

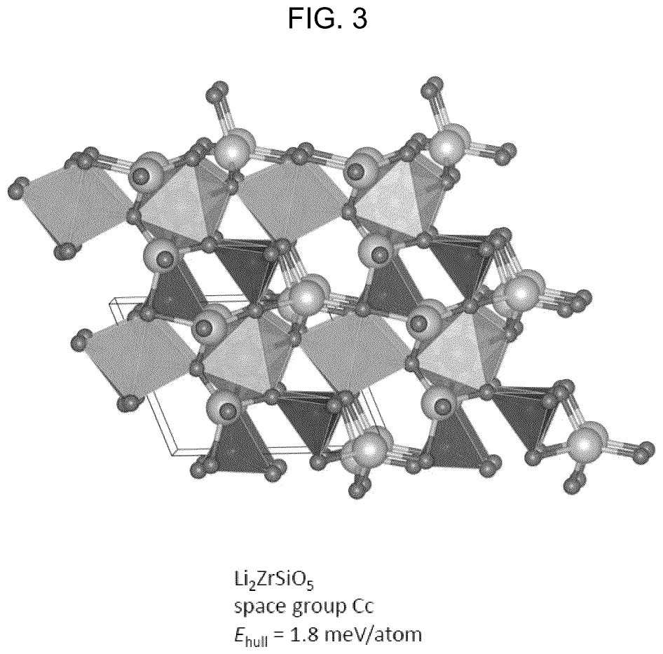

FIGS. 2 and 3 show crystal structures of top 2 Li ion conductors with the formula of Li2ZrSiO5, namely, Li2ZrSiO5 crystallized in space group Pc or Pna2₁ and Li2ZrSiO5 crystallized in space group Cc, respectively. Red colored spheres: O anions, blue polyhedrons: Si cations, green polyhedrons: Zr cations, green spheres: Li cations.

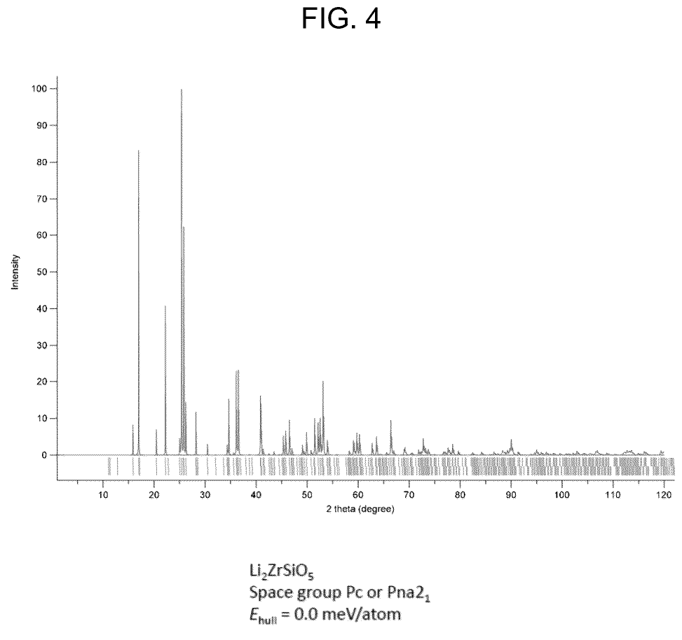

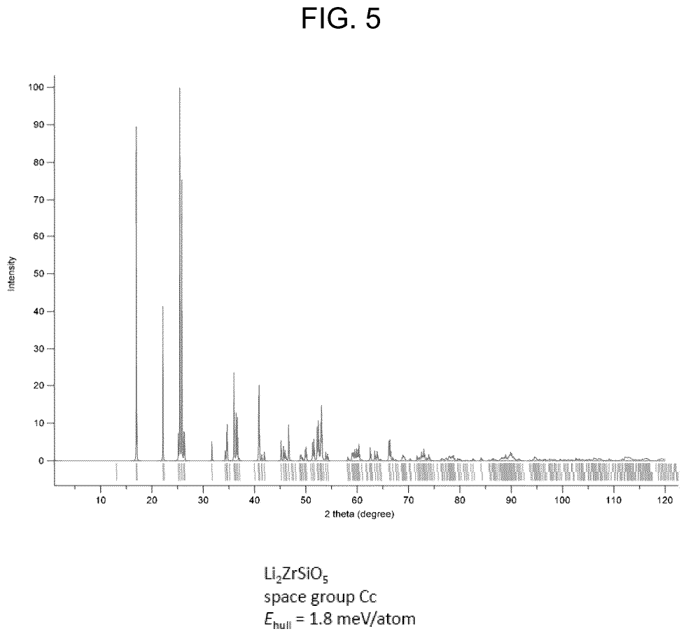

FIGS. 4 and 5 show the calculated powder diffraction patterns of top 2 Li ion conductors with the formula of Li2ZrSiO5, namely, Li2ZrSiO5 crystallized in space group Pc or Pna2₁ and Li2ZrSiO5 crystallized in space group Cc, respectively.

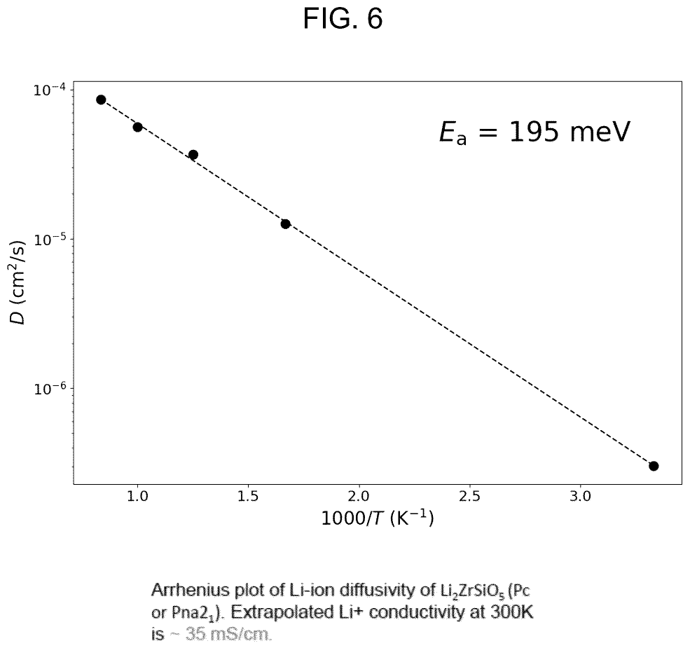

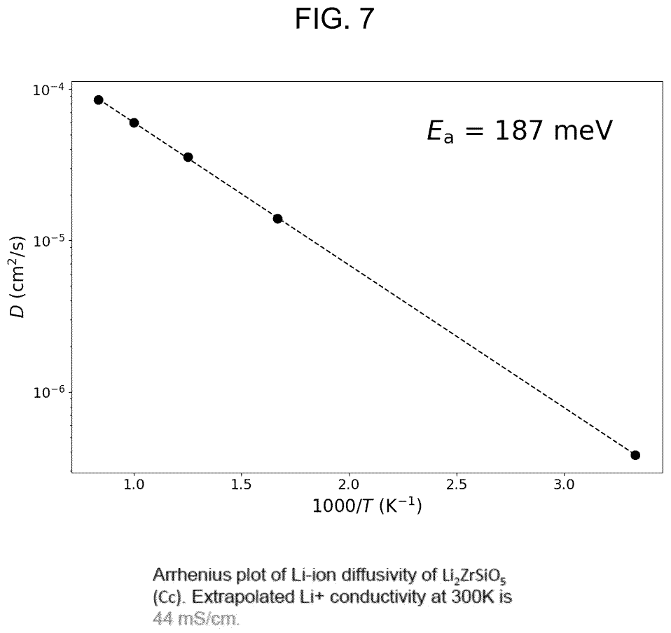

FIGS. 6 and 7 are a graph showing the calculated Li-ion conductivity of Li2ZrSiO5 crystallized in space group Pc or Pna2₁ and Li2ZrSiO5 crystallized in space group Cc, respectively.

High-throughput data-mining was conducted to derive novel prototype Li-containing structures, and advanced data analytics was performed to extract novel Li-ion conductors that are stable against Li metal, stable anolyte against various types of anodes such as alloy anode or graphite anode, stable catholytes and stable coating materials in all-solid state batteries.

The lithium-containing oxides in this disclosure can be made by a standard solid-state method. In this method, precursor powders are combined in a certain ratio depending on the composition of the target material. As one example, precursors may consist of lithium carbonate (Li₂CO₃), zirconium oxide (ZrO₂), and silica (SiO₂), and as another example, precursors may consist of lithium oxide (Li₂O), zirconium oxide, and silica.

The precursor mixture may be mixed by a method such as ball milling or planetary milling to produce a homogeneous mixture. Mixing may be done with a suitable solvent such as ethanol, isopropanol, ethylene glycol, or acetone to assist with the uniform dispersion of the precursors.

The precursor mixture may then be heat treated to an appropriate temperature (e.g., 500-1000° C.) for an appropriate period of time (e.g., 6-12 hours) to produce a powder with the desired composition and crystal structure.

Subsequently, the powder may be compressed using a hydraulic uniaxial press to form a densely packed pellet. Heat treatment may then be applied at an appropriate temperature (e.g., 500-1000° C.) for an appropriate period of time (e.g., 6-12 hours) to produce a dense pellet which may be used as a solid electrolyte separator in a solid state lithium battery cell.

An embodiment of the aforementioned solid electrolyte separator can be assembled together with a cathode active material layer and an anode active material layer to be used in an embodiment which is a solid state lithium battery comprising a cathode active material layer, an anode active material layer, and a solid electrolyte layer formed between the cathode active material layer and the anode active material layer, wherein the solid electrolyte layer comprises any of the aforementioned materials.

The lithium-containing oxides in this disclosure can be used as a solid electrolyte material for Li batteries and/or electrode coatings for solid-state batteries.

This disclosure provides lower cost/high conductivity and high aqueous stability solid electrolyte for use in Li solid-state batteries.

### EXAMPLES

Embodiments will now be illustrated by way of the following examples, which do not limit the embodiments in any way.

A machine learning-based crystal structure prediction algorithm was applied to obtain the following compositions as set forth in Table 1.

TABLE 1

| | | chemical | | | | | | |
|---|---|---|---|---|---|---|---|---|
| Host ID | Formula | space | Mobile ion | E_3D | Vred (V) | Vox (V) | Ehull (meV/atom) | SPG |
| 1 | Li2ZrSiO5 | Li—O—Si—Zr | Li | 0.4883 | 0.83 | 3.74 | 0.0 | Pna2₁ or Pc |
| 2 | Li2ZrSiO5 | Li—O—Si—Zr | Li | 0.459 | 0.83 | 3.74 | 1.7938847 | Cc |
| 19624 | Li2ZrSiO5 | Li—O—Si—Zr | Li | 0.5957 | 0.83 | 3.74 | 14.052586100000001 | P2₁/c |
| 50 | Li2ZrSiO5 | Li—O—Si—Zr | Li | 1.582 | 0.83 | 3.74 | 19.6443897 | Pmn2₁ |
| 8 | Li2ZrSiO5 | Li—O—Si—Zr | Li | 1.5723 | 0.83 | 3.74 | 19.8062592 | Pmn2₁ |
| 19858 | Li2ZrSiO5 | Li—O—Si—Zr | Li | 1.5918 | 0.83 | 3.74 | 21.780878100000002 | P4/nmm |
| 19648 | Li2ZrSiO5 | Li—O—Si—Zr | Li | 3.0566 | 0.83 | 3.74 | 22.3003028 | Pbca |
| 19120 | Li2ZrSiO5 | Li—O—Si—Zr | Li | 1.748 | 0.83 | 3.74 | 26.0258007 | P2₁/c |
| 19662 | Li2ZrSiO5 | Li—O—Si—Zr | Li | 0.6348 | 0.83 | 3.74 | 33.1359403 | C2/c |
| 19924 | Li2ZrSiO5 | Li—O—Si—Zr | Li | 1.5625 | 0.83 | 3.74 | 35.0066067 | P2₁/c |
| 20047 | Li2ZrSiO5 | Li—O—Si—Zr | Li | 0.6543 | 0.83 | 3.74 | 35.8061258 | C2/c |
| 20043 | Li2ZrSiO5 | Li—O—Si—Zr | Li | 0.7129 | 0.83 | 3.74 | 37.8877786 | C2/c |
| 19437 | Li2ZrSiO5 | Li—O—Si—Zr | Li | 0.7812 | 0.83 | 3.74 | 38.9136333 | P2₁/c |
| 3 | Li2ZrSiO5 | Li—O—Si—Zr | Li | 0.6152 | 0.83 | 3.74 | 46.992169700000005 | P2₁2₁2₁ |
| 19434 | Li2ZrSiO5 | Li—O—Si—Zr | Li | 1.8555 | 0.83 | 3.74 | 47.777667199999996 | P2₁/c |
| 19667 | Li2ZrSiO5 | Li—O—Si—Zr | Li | 1.1719 | 0.83 | 3.74 | 50.885078299999996 | Pmc2₁ |
| 33 | Li2ZrSiO5 | Li—O—Si—Zr | Li | 3.5938 | 0.83 | 3.74 | 53.4266953 | P2₁ |
| 5 | Li2ZrSiO5 | Li—O—Si—Zr | Li | 0.8008 | 0.83 | 3.74 | 53.4949525 | Pca2₁ |
| 4 | Li2ZrSiO5 | Li—O—Si—Zr | Li | 0.459 | 0.83 | 3.74 | 53.9648022 | P43 |
| 42 | Li2ZrSiO5 | Li—O—Si—Zr | Li | 2.1484 | 0.83 | 3.74 | 58.5734192 | P2₁ |

As can be seen from the results presented in Table 1, the 0.83 V reduction potential against Li and the 3.74 V oxidation potential for the Li2ZrSiO5 composition suggest that the composition can be used as anolyte against an alloy anode or graphite anode, or catholyte against cathodes with coatings (again, in batteries, these materials as solid-state electrolyte can form solid-electrolyte interphases by chemical reaction with electrodes and widen the redox potential window of the electrolytes).

The foregoing is illustrative of exemplary embodiments and is not to be construed as limiting the disclosure. Although a few exemplary embodiments have been described, those skilled in the art will readily appreciate that many modifications are possible in the above embodiments without materially departing from the disclosure.

What is claimed is:

1. A lithium-containing oxide comprising Li2ZrSiO5 which is crystallized in space group Pc, Cc, Pmn2₁, P2₁, Pna2₁, P2₁2₁2₁, P4₃, Pca2₁, P2₁/c, Pbca, C2/c, Pmc2₁, or P4/nmm.

2. The lithium-containing oxide of claim 1, wherein the lithium-containing oxide is Li2ZrSiO5 crystallized in space group Pc.

3. The lithium-containing oxide of claim 1, wherein the lithium-containing oxide is Li2ZrSiO5 crystallized in space group Cc.

4. The lithium-containing oxide of claim 1, wherein the lithium-containing oxide is Li2ZrSiO5 crystallized in space group Pmn2₁.

5. The lithium-containing oxide of claim 1, wherein the lithium-containing oxide is Li2ZrSiO5 crystallized in space group P2₁.

6. The lithium-containing oxide of claim 1, wherein the lithium-containing oxide is Li2ZrSiO5 crystallized in space group Pna2₁.

7. The lithium-containing oxide of claim 1, wherein the lithium-containing oxide is Li2ZrSiO5 crystallized in space group P2₁2₁2₁.

8. The lithium-containing oxide of claim 1, wherein the lithium-containing oxide is Li2ZrSiO5 crystallized in space group P4₃.

9. The lithium-containing oxide of claim 1, wherein the lithium-containing oxide is Li2ZrSiO5 crystallized in space group Pca2₁.

10. The lithium-containing oxide of claim 1, wherein the lithium-containing oxide is Li2ZrSiO5 crystallized in space group P2₁/c.

11. The lithium-containing oxide of claim 1, wherein the lithium-containing oxide is Li2ZrSiO5 crystallized in space group Pbca.

12. The lithium-containing oxide of claim 1, wherein the lithium-containing oxide is Li2ZrSiO5 crystallized in space group C2/c.

13. The lithium-containing oxide of claim 1, wherein the lithium-containing oxide is Li2ZrSiO5 crystallized in space group Pmc2₁.

14. The lithium-containing oxide of claim 1, wherein the lithium-containing oxide is Li2ZrSiO5 crystallized in space group P4/nmm.

15. A lithium solid-state battery comprising an anode, a cathode, and a solid electrolyte, wherein the solid electrolyte comprises a lithium-containing oxide of parent composition Li2ZrSiO5.

16. The lithium solid-state battery of claim 15, wherein the solid electrolyte comprises Li2ZrSiO5 crystallized in space group Pc, Cc, Pmn2₁, P2₁, Pna2₁, P2₁2₁2₁, P4₃, Pca2₁, P2₁/c, Pbca, C2/c, Pmc2₁, or P4/nmm.

17. A lithium solid-state battery comprising an anode, a cathode, and a solid electrolyte, wherein at least one of the anode and the cathode is coated with a coating which comprises a lithium-containing oxide of claim 1.

18. The lithium solid-state battery of claim 17, wherein the coating comprises Li2ZrSiO5 crystallized in space group Cc.

19. The lithium solid-state battery of claim 17, wherein the cathode is coated with the coating which comprises the lithium-containing oxide.

20. The lithium solid-state battery of claim 18, wherein the cathode is coated with the coating which comprises Li2ZrSiO5 crystallized in space group Cc.
